(19) United States
(12) Patent Application Publication
(10) Pub. No.: US 2025/0026068 A1
(43) Pub. Date: Jan. 23, 2025

(54) Steam Heating And Molding Of Nonwoven Materials

(71) Applicant: Auria Solutions UK I, Ltd., London (GB)

(72) Inventors: Stefan KOENIGBAUER, Northville, MI (US); Timothy Joel ALLISON, Marion, NC (US); Ernest Franklin WILSON, Albemarle, NC (US)

(21) Appl. No.: 18/776,696

(22) Filed: Jul. 18, 2024

Related U.S. Application Data
(60) Provisional application No. 63/514,224, filed on Jul. 18, 2023.

(51) Int. Cl. B29C 51/42; B29C 51/00; B29K 105/08; B29L 31/30

(52) U.S. Cl. CPC B29C 51/424; B29C 51/004; B29K 2105/0854; B29K 2995/0002; B29K 2995/0097; B29L 2031/3041

(57) ABSTRACT

Steam heating and molding of single or multilayer nonwoven materials, particularly suitable for the formation of three-dimensionally shaped automotive sound insulators.

### FIELD

The present invention is directed at steam heating and molding of single or multilayer nonwoven materials, particularly suitable for the formation of three-dimensionally shaped automotive sound insulators.

### BACKGROUND

It has been a long-standing effort to reduce the level of noise within a vehicle. As a consequence, sound-attenuating materials for vehicles may be positioned at a variety of locations within the vehicle, such as in the dashboard, vehicle flooring, wheel wells, under the hood, in the trunk compartment, as part of a headliner, in the A-pillars, etc.

Typically, many of these sound-attenuating materials are either single or multilayer composite materials, relying upon one or more nonwoven layers, that may be tuned to achieve particular types of acoustical absorption or insulation.

One example of a method for manufacturing an interior trim component for noise attenuation in a vehicle is reported in U.S. Pat. No. 7,698,817 entitled Methods of Forming Vehicle Interior Components Which Include A Decoupler Layer. As disclosed therein the method involves conveying of materials into an enclosure to form a preform, heating the preform such that adjacent materials may bond to one another, and forming the heating preform into a predetermined three-dimensional decoupler by molding.

Accordingly, a need remains to provide more efficient methods to provide for single or multilayer nonwoven type composite materials that may then serve to provide noise abatement in a vehicle application.

### SUMMARY

A system for forming a three-dimensional nonwoven structure comprising: a steam heating chamber configured to heat a nonwoven substrate with saturated steam and/or superheated steam, wherein said nonwoven substrate comprises one or a plurality of layers, a mold configured to form said heated nonwoven substrate into a three-dimensional shape, and a conveyor configured to deliver said nonwoven substrate into said steam heating chamber and into said mold

A method for forming a three-dimensional nonwoven structure comprising: supplying a steam heating chamber configured to heat a nonwoven substrate with saturated steam and/or superheated steam wherein said nonwoven substrate comprises one or a plurality of layers; providing a mold configured to form said heated nonwoven substrate into a three-dimensional shape; heating said nonwoven substrate with steam and/or superheated steam for a period of time of 1 second to 60 seconds; and placing said heated nonwoven substrate from step (c) into said mold and forming said three-dimensional nonwoven structure.

### FIGURES

FIG. 1 illustrates the temperature versus pressure profile for superheated steam that may be employed to preheat the one or plurality of nonwoven layers.

FIG. 2 illustrates a preferred molding assembly for steam-heating and molding of a single layer or multi-layer nonwoven materials.

FIG. 3 illustrates the use of the steam heated chamber herein for steam heating of a multilayer composite.

### DETAILED DESCRIPTION OF PREFERRED EMBODIMENTS

The present invention stands directed to heating of monolayer or multilayer nonwoven type material with steam prior to molding. The steam is preferably saturated steam (steam in equilibrium with water at the same temperature). The steam may also preferably be superheated steam, which is reference to steam that has a temperature higher than its vaporization (boiling) point at absolute pressure. The advantage of superheated steam for use in heating of a layer of nonwoven material is that the superheated steam contains a relatively high energy stored therein and can cool by some amount resulting in lowering of temperature without changing state and e.g., condensing from a gas to a mixture of saturated vapor and water.

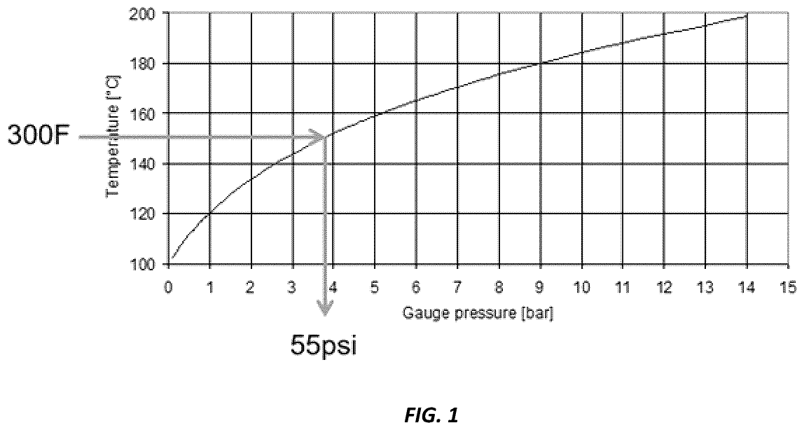

FIG. 1 illustrates the temperature versus pressure profile for superheated steam that may be employed to preheat the one or plurality of nonwoven layers. Preferably, the superheated steam herein is such it is provided a pressure in the range of greater than 1 bar (14.5 psi) to 10 bar (145 psi). However, in the broad context of the present invention, the superheated steam may be at any pressure of greater than 1 bar to 15 bar, which therefore would provide a temperature for preheating of the nonwoven layer(s) of greater than 100° C. to 220° C.

As may therefore be appreciated, by use of superheated steam, one may select a temperature that is otherwise needed to heat and soften a give polymeric material utilized in the nonwoven, to provide for thermal bonding. For example, when utilizing a nonwoven that may contain bicomponent polyester fibers, with a sheath-core construction, with the relatively lower melting sheath, the superheated steam may now melt the sheath and allow for fiber bonding, without melting the core. Such bicomponent fibers may preferably include a polyethylene terephthalate (PET) core, with a melting point of about 260° C. and a sheath of a relatively lower melting polyester having a melting point in the range of 100° C. to 200° C. Such relatively lower melting sheath therefore makes it particularly suitable for melting in the presence of the superheated steam herein.

The polymer resins in fiber form in the nonwoven that may be subject to steam heating herein can contain either virgin or recycled fibers, as well as mixtures of the two. The particular polymer resins for the aforementioned fibers are contemplated to preferably include polyester or polyester copolymers (e.g., PET or PETG), acrylic, polyamide, aramid, wool, polyolefins (e.g. polyethylene or polypropylene), polyacrylonitrile (PAN), rayon, and shoddy fiber (nonwoven material made from recycled shredded fibers), where the shoddy fibers preferably include a binder fiber. The binder fiber may preferably be selected from polyester, polyester copolymer, polyamide, polyamide copolymer or polyolefin. In such context, the polymers preferably included herein include those polymers in fiber form that are susceptible to water absorption and a plasticizing effect that may otherwise lower transition temperatures (e.g. Tm or Tg). This then can allow for softening and molding at relatively lower temperature than in the relatively dry state.

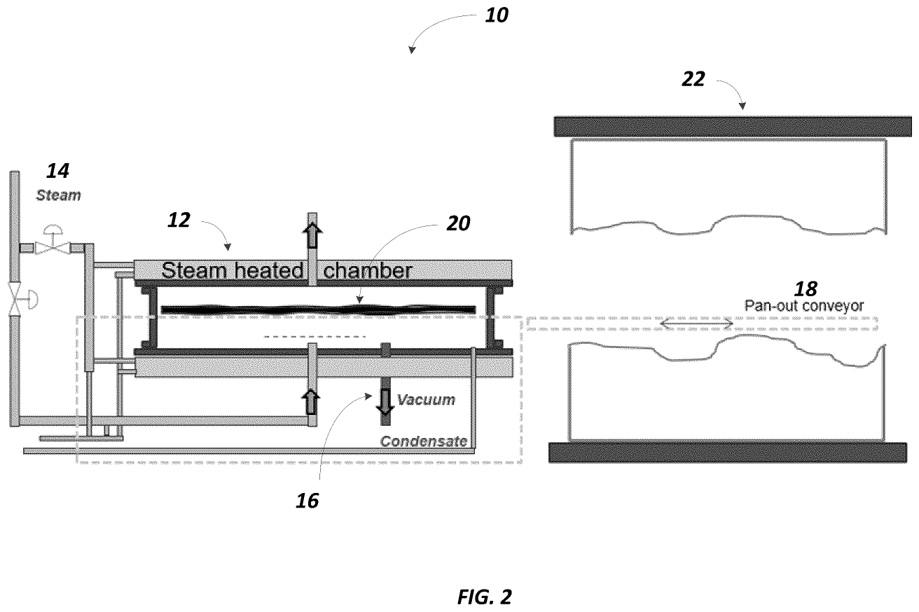

Attention is directed to FIG. 2 which illustrates a preferred molding assembly for steam-heating and molding of a single layer or multi-layer nonwoven materials. For example, such may preferably include a single layer of nonwoven felt with any one of the above-mentioned polymer fibers. It may also include a dual layer felt with each layer having different densities, including bicomponent fiber binder. It may also simply include a single layer nonwoven, along with bicomponent fiber binder.

As can therefore be seen in FIG. 2, the molding assembly 10 includes a steam-heated chamber 12. The chamber 10 can provide saturated steam or superheated steam, 14 which can preferably be cycled through two shut-off valves so that such steam can preferably be introduced at the bottom of the steam-heated chamber. The steam-heated chamber also may include a vacuum port 16 to assist in removal of any water condensate. A conveyor assembly 18 is provided that conveniently provides for the ability to insert a nonwoven substrate 20 into the steam-heated chamber 12. The heated material(s) may be conveyed manually or by other automation as is known to the industry. The nonwoven substrate herein may preferably have a thickness in the range of 3.0 mm to 110.0 mm, including all individual values and increments therein.

The molding assembly 10 also preferably includes a mold 22 which can apply compression to the preheated nonwoven substrate 20. The mold may preferably apply a compression force to the nonwoven substrate in the range of 3.75 tons to 100 tons, including all values and increments therein. As may therefore be appreciated, the nonwoven substrate containing one or a plurality of nonwoven layers can be readily cycled into the steam-heated chamber 12 for steam preheating, and then into mold 22, where it can be compressed and formed into a desired three-dimensional shape. Given the steam preheating of the nonwoven substrate, as noted, the actual press force that is then applied to the nonwoven in the mold may preferably fall in the range 3.75 tons to 100 tons, or in the range of 0.15 N/mm² to 3.0 N/mm², including all individual values and increments therein.

By way of one representative molding cycle, the nonwoven substrate 20 can be introduced into the steam heated chamber 12 followed by a vacuum cycle of around 5-10 seconds. This may then be followed by a steam-pressure build up cycle of about 5-10 seconds wherein as noted, the pressure may be set in the range of greater than 1 bar to 15 bar to thereby provide superheated steam temperatures in the preferred range of greater than 100° C. to 200° C. This may then be followed by a static steam pressure cycle in the range of about 1-5 seconds. This may then be followed by a degassing cycle in the range of 1-5 seconds and then the steam heated chamber 12 is opened.

Accordingly, it may be appreciated that in broad embodiment, the nonwoven substrate may be exposed to steam and/or superheated steam for a time period of 1 second to 60 seconds, more preferably 5 seconds to 30 seconds, or even 5 seconds to 15 seconds. As noted herein, the steam itself associated with such cycle times of exposure may be preferably be superheated steam at any pressure of greater than 1 bar to 15 bar, which therefore would provide a temperature for preheating of the nonwoven substrate of greater than 100° C. to 200° C.

Accordingly, it can be appreciated that the overall cycle time for steam pre-heating of a nonwoven substrate, containing one or a plurality of nonwoven layers, within the steam heated chamber 12, is sufficient to allow for ensuing molding and formation of a three-dimensional part, and can be in the range of 30 seconds to 60 seconds. More preferably, such cycle time may be in the range of 35 second to 45 seconds. The single layer nonwoven or multilayer nonwovens herein, suitable for the aforementioned steam preheating, preferably have an individual layer thickness in the range of 4.0 mm to 35 mm, where the individual layers preferably have a basis weight in the range of 200 gsm-2000 gsm. Accordingly, the nonwoven herein that is subject to steam heating and molding may itself have, in the case of a single layer, a total thickness in the range of 3.0 mm to 110.0 mm, including all individual values and increments therein. When multilayers are present the number of layers may comprise 2, 3, 4 or 5 layers, and therefore range from 2-5 layers, or 2-4 layers, or 2-3 layers.

There are several contemplated advantages of preheating the nonwoven substrate herein followed by compression into a desired three-dimensional shape. For example, as noted, utilizing steam heating, such is particularly efficient for use with a nonwoven, that provides a relatively porous medium for steam penetration. In addition, preheating with steam provides relatively good temperature control (see again FIG. 1) and relatively uniform and relatively fast heating of the nonwoven, whether it be present as a single or multilayer substrate. As alluded to above, the cycle time for the placement of the single or multilayer nonwoven substrate, in the steam heated chamber 12, can preferably be configured to be less than or equal to 60 seconds.

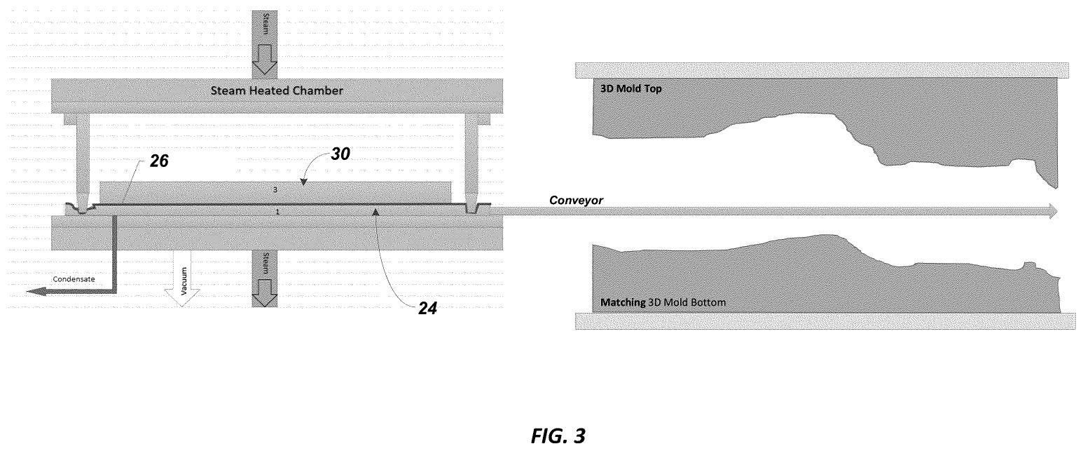

FIG. 3 shows the use of the steam heated chamber herein for steam heating of a multilayer composite. The multilayer composite includes an acoustic layer 24 that has a thickness of 5.0 to 30.0 mm at a basis weight of 100 gsm to 2500 gsm, including all individual values and increments therein of either thickness or basis weight. The acoustic layer is preferably made of a mixture of polyester (e.g., a polyester bicomponent fiber) and shoddy. However, the acoustic layer may be sourced from thermoplastic polymer fiber or thermoset polymer fiber, or natural fibers such as cotton Also shown at 26 is what can be described as a melt film layer, which is at a preferred thickness in the range of 0.01 mm to 0.05 mm. The melt film layer is preferably made of thermoplastic polymer examples of which include polyethylene (e.g. LDPE or LLDPE) or ethylene-methyl methacrylate (EMA) resins. The resins are those that preferably melt and become semiporous due to the heat and pressure of the steam molding applied herein. In addition, there is an upper layer 30 that may be described as a lofted decoupler/absorber layer that preferably has a thickness in the range of 5.0 mm to 30.0 mm at a basis weight of 500 gsm to 2000 gsm, including all values and increments therein of either thickness or basis weight. Upper layer 30 is preferably made of the same acoustic fibers used for the above referenced acoustic layer, also at a basis weight in the range of 100 gsm to 2500 gsm, and at a preferred thickness of 1.0 mm to 75.0 mm.

The airflow resistance of the steam heated and compressed nonwoven herein may preferably fall in the range of 600 Rayls to 8000 Rayls. A Rayl equals 1 pascal-second per meter.

As therefore may be appreciated, the present invention provides a relatively more efficient route to preheating of a single or multilayer nonwoven, that can then be compressed into a desired three-dimensional shape. Such three-dimensional shapes may preferably include interior trim components for noise attenuation in a vehicle.

1. A system for forming a three-dimensional nonwoven structure comprising:
a. a steam heating chamber configured to heat a nonwoven substrate with saturated steam and/or superheated steam, wherein said nonwoven substrate comprises one or a plurality of layers;
b. a mold configured to form said heated nonwoven substrate into a three-dimensional shape; and
c. a conveyor configured to deliver said nonwoven substrate into said steam heating chamber and into said mold.

2. The system of claim 1 wherein said steam heating chamber provides superheated steam at a pressure of greater than 1 bar to 15 bar and at a temperature of greater than 100° C. to 220° C.

3. The system of claim 1 wherein said nonwoven substrate is selected from the group consisting of polyesters, polyester copolymers, acrylic, polyamide, aramid, wool, polyolefins, polyacrylonitrile, rayon, or shoddy fibers.

4. The system of claim 1 wherein said nonwoven substrate has a thickness in the range of 3.0 mm to 110.0 mm.

5. The system of claim 1 wherein said mold applies a press force to said nonwoven in the range of 3.75 tons to 100 tons.

6. A method for forming a three-dimensional nonwoven structure comprising:
a. supplying a steam heating chamber configured to heat a nonwoven substrate with saturated steam and/or superheated steam wherein said nonwoven substrate comprises one or a plurality of layers;
b. providing a mold configured to form said heated nonwoven substrate into a three-dimensional shape;
c. heating said nonwoven substrate with steam and/or superheated steam for a period of time of 1 second to 60 seconds;
d. placing said heated nonwoven substrate from step (c) into said mold and forming said three-dimensional nonwoven structure.

7. The method of claim 6 wherein said steam comprises superheated steam at a pressure of greater than 1 bar to 15 bar and at a temperature of greater than 100° C. to 220° C.

8. The method of claim 6 wherein said nonwoven substrate is selected from the group consisting of polyesters, polyester copolymers, acrylic, polyamide, aramid, wool, polyolefins, polyacrylonitrile, rayon, or shoddy fibers.

9. The method of claim 6 wherein said nonwoven substrate has a thickness in the range of 3.0 mm to 110.0 mm.

10. The method of claim 6 wherein said mold applies a press force to said nonwoven in the range of 3.75 tons to 100 tons.
